(19) United States
(12) Patent Application Publication
(10) Pub. No.: US 2015/0020947 A1
(43) Pub. Date: Jan. 22, 2015

(54) METHOD FOR THE MANUFACTURE OF COMPOSITE SEPARATORS

(71) Applicant: SOLVAY SPECIALTY POLYMERS ITALY S.P.A., Bollate, MI (US)

(72) Inventors: Milena Stanga, Origgio (IT); Riccardo Pieri, Milano (IT); Marco Miele, Cisliano (IT)

(73) Assignee: SOLVAY SPECIALTY POLYMERS ITALY S.P.A., Bollate (IT)

(21) Appl. No.: 14/378,134

(22) PCT Filed: Feb. 12, 2013
(86) PCT No.: PCT/EP2013/052797

§ 371 Date: Aug. 12, 2014

(30) Foreign Application Priority Data
Feb. 16, 2012 (EP) 12155839.9

(51) Int. Cl. H01M 2/16; C09D 127/16; H01M 2/14

(52) U.S. Cl. CPC H01M 2/166; H01M 2/145; H01M 2/1686; C09D 127/16
USPC 156/60; 427/58; 524/545

(57) ABSTRACT

The present invention pertains to a process for the manufacture of a composite separator for an electrochemical cell, said process comprising the following steps: (i) providing a substrate layer; (ii) providing a coating composition comprising: —an aqueous latex comprising at least one vinylidene fluoride (VdF) polymer [polymer (F)] under the form of primary particles having an average primary particle size of less than 1 μm, as measured according to ISO 13321, and —at least one non-electroactive inorganic filler material; (iii) applying said coating composition onto at least one surface of said substrate layer to provide a coating composition layer; and (iv) drying said coating composition layer at a temperature of at least 60° C., preferably of at least 100° C., more preferably of at least 180° C. to provide said composite separator. The present invention also pertains to a coating composition suitable for use in said process, to the composite separator obtained from said process and to an electrochemical cell comprising said composite separator.

This application claims priority to European application No. 12155839.9 filed on Feb. 16, 2012, the whole content of this application being incorporated herein by reference for all purposes.

### TECHNICAL FIELD

The present invention relates to a process for the manufacture of a composite separator for an electrochemical cell, to a coating composition suitable for use in said process, to the composite separator obtained from said process and to an electrochemical cell comprising said composite separator.

### BACKGROUND ART

Vinylidene fluoride polymers are known in the art to be suitable as binders for the manufacture of composite separators for use in non-aqueous-type electrochemical devices such as batteries, preferably secondary batteries, and electric double layer capacitors.

Inorganic filler materials have been long used to fabricate battery separators having a composite structure, said composite separators comprising the filler materials distributed in a polymeric binder matrix. These filler materials are typically produced as finely divided solid particulates and used as a vehicle for introducing porosity in the separator and for reinforcing the polymeric binder material used to fabricate the separator.

A separator precursor solution is typically formulated as an ink or paste comprising a solid particulate material dispersed in a solution of a polymer binder in a suitable solvent. The ink solution so obtained is usually disposed onto a surface of an electrode layer and the solvent is then removed from the solution layer to deposit a separator layer which adheres to the electrode.

However, a solvent system is typically used to disperse the polymer binder, which generally comprises N-methylpyrrolidone or mixtures of N-methylpyrrolidone and a diluting solvent such as acetone, propyl acetate, methyl ethyl ketone and ethyl acetate.

For instance, US 2002/0168569 (ATOFINA) Nov. 14, 2002 discloses a process for manufacturing separators for Lithium-ion batteries, said process comprising processing a microcomposite powder comprising from 20% to 80% by weight of a fluoropolymer and from 80% to 20% by weight of fillers. This microcomposite powder may be processed in order to result in separators suitable for use in Lithium-ion batteries notably by dispersion in water or in a solvent such as acetone or N-methyl-2-pyrrolidone to obtain a paste which is then applied to a support by doctor blading and dried.

There is thus a need in the art for an environmentally-friendly process enabling easy manufacture of composite separators suitable for use in electrochemical devices.

### SUMMARY OF INVENTION

It has been now developed a process for the manufacture of a composite separator for an electrochemical cell, said process advantageously allowing using aqueous vinylidene fluoride polymer compositions as obtained by emulsion polymerization, without the need for isolating polymer powders from said compositions and dispersing them in suitable organic solvents.

It is thus an object of the present invention a process for the manufacture of a composite separator for an electrochemical cell, said process comprising the following steps:

(i) providing a substrate layer;
(ii) providing a coating composition comprising:
an aqueous latex comprising at least one vinylidene fluoride (VdF) polymer [polymer (F)] under the form of primary particles having an average primary particle size of less than 1 μm, as measured according to ISO 13321, and
at least one non-electroactive inorganic filler material;
   (iii) applying said coating composition onto at least one surface of said substrate layer to provide a coating composition layer; and
   (iv) drying said coating composition layer at a temperature of at least 60° C., preferably of at least 100° C., more preferably of at least 180° C. to provide said composite separator.

According to an embodiment of the process of the invention, the process further comprises curing the composite separator obtained from said process.

By the term “separator”, it is hereby intended to denote a porous monolayer or multilayer polymeric material which electrically and physically separates electrodes of opposite polarities in an electrochemical cell and is permeable to ions flowing between them.

By the term “electrochemical cell”, it is hereby intended to denote an electrochemical cell comprising a positive electrode, a negative electrode and a liquid electrolyte, wherein a monolayer or multilayer separator is adhered to at least one surface of one of said electrodes.

Non-limitative examples of electrochemical cells include, notably, batteries, preferably secondary batteries, and electric double layer capacitors.

For the purpose of the present invention, by “secondary battery” it is intended to denote a rechargeable battery. Non-limitative examples of secondary batteries include, notably, alkaline or alkaline-earth secondary batteries.

By the term “composite separator”, it is hereby intended to denote a separator as defined above wherein non-electroactive inorganic filler materials are incorporated into a polymeric binder material.

The composite separator obtained from the process of the invention is advantageously an electrically insulating composite separator suitable for use in an electrochemical cell.

When used in an electrochemical cell, the composite separator is generally filled with a liquid electrolyte which advantageously allows ionic conduction within the electrochemical cell.

The composite separator obtained from the process of the invention advantageously comprises the non-electroactive inorganic filler material uniformly distributed within the polymer (F) matrix.

By the term “non-electroactive inorganic filler material”, it is hereby intended to denote an electrically non-conducting inorganic filler material which is suitable for the manufacture of an electrically insulating separator for electrochemical cells.

The non-electroactive inorganic filler material typically has an electrical resistivity (ρ) of at least 0.1×10¹⁰ ohm·cm, preferably of at least 0.1×10¹² ohm·cm, as measured at 20° C. according to ASTM D 257.

Non-limitative examples of suitable non-electroactive inorganic filler materials include, notably, natural and synthetic silicas, zeolites, aluminas, titanias, metal carbonates, zirconias, silicon phosphates and silicates and the like.

The non-electroactive inorganic filler material is typically under the form of particles having an average size of from 0.01 μm to 50 μm, as measured according to ISO 13321.

The non-electroactive inorganic filler material is successfully uniformly dispersed in the polymer (F) matrix to form pores having an average diameter of from 0.1 μm to 5 μm.

The pore volume fraction of the composite separator obtained from the process of the invention is at least 25%, preferably at least 40%.

The composite separator obtained from the process of the invention has a total thickness typically comprised between 2 μm and 100 μm, preferably between 2 μm and 40 μm.

For the purpose of the present invention, by “aqueous latex comprising at least one vinylidene fluoride (VdF) polymer [polymer (F)]” it is intended to denote an aqueous polymer (F) latex directly deriving from aqueous emulsion polymerization.

The aqueous latex of the coating composition of the process of the invention is thus to be intended distinguishable from an aqueous slurry prepared by dispersing polymer (F) powders in an aqueous medium. The average particle size of polymer (F) powders dispersed in an aqueous slurry is typically higher than 1 μm, as measured according to ISO 13321.

The aqueous latex of the coating composition of the process of the invention advantageously has homogeneously dispersed therein primary particles of at least one polymer (F) having an average primary particle size of less than 1 μm, as measured according to ISO 13321.

The aqueous latex of the coating composition of the process of the invention advantageously has homogeneously dispersed therein primary particles of at least polymer (F) having an average primary particle size comprised between 50 nm and 600 nm, preferably between 60 nm and 500 nm, more preferably between 80 nm and 400 nm, as measured according to ISO 13321.

For the purpose of the present invention, by “average primary particle size” it is intended to denote primary particles of polymer (F) deriving from aqueous emulsion polymerization. Primary particles of polymer (F) are thus to be intended distinguishable from agglomerates (i.e. collection of primary particles) which might be obtained by recovery and conditioning steps of polymer (F) manufacture such as concentration and/or coagulation of aqueous polymer (F) latexes and subsequent drying and homogenization to yield polymer (F) powders.

It has been found that the aqueous polymer (F) latex of the coating composition of the process of the invention is successfully stable prior and after admixing with non-electroactive inorganic filler materials so as to enable easily manufacturing composite separators for electrochemical cells.

It has been found that an aqueous polymer (F) slurry has no suitable particle size and no sufficient stability prior and after admixing with non-electroactive inorganic filler materials so that it cannot be used as such in a process for the manufacture of composite separators for electrochemical cells.

For the purpose of the present invention, by “vinylidene fluoride (VdF) polymer [polymer (F)]” it is intended to denote a polymer comprising recurring units derived from vinylidene fluoride (VdF).

The polymer (F) comprises typically at least 50% by moles, preferably at least 70%, more preferably at least 80% by moles of recurring units derived from vinylidene fluoride (VdF).

The polymer (F) may further comprise recurring units derived from at least one comonomer (C), said comonomer (C) being different from vinylidene fluoride (VdF).

The comonomer (C) can be either a hydrogenated comonomer [comonomer (H)] or a fluorinated comonomer [comonomer (F)].

By the term “hydrogenated comonomer [comonomer (H)]”, it is hereby intended to denote an ethylenically unsaturated comonomer free of fluorine atoms.

Non-limitative examples of suitable hydrogenated comonomers (H) include, notably, ethylene, propylene, vinyl monomers such as vinyl acetate, as well as styrene monomers, like styrene and p-methylstyrene.

By the term “fluorinated comonomer [comonomer (F)]”, it is hereby intended to denote an ethylenically unsaturated comonomer comprising at least one fluorine atom.

The comonomer (C) is preferably a fluorinated comonomer [comonomer (F)].

Non-limitative examples of suitable fluorinated comonomers (F) include, notably, the followings:

(a) C₂-C₈ fluoro- and/or perfluoroolefins such as tetrafluoroethylene (TFE), hexafluoropropylene (HFP), pentafluoropropylene and hexafluoroisobutylene;
(b) C₂-C₈ hydrogenated monofluoroolefins such as vinyl fluoride, 1,2-difluoroethylene and trifluoroethylene;
(c) perfluoroalkylethylenes of formula CH₂═CH—R_{f0}, wherein R_{f0} is a C₁-C₆ perfluoroalkyl group;
(d) chloro- and/or bromo- and/or iodo-C₂-C₆ fluoroolefins such as chlorotrifluoroethylene (CTFE);
(e) (per)fluoroalkylvinylethers of formula CF₂═CFOR_{f1}, wherein R_{f1} is a C₁-C₆ fluoro- or perfluoroalkyl group, e.g. —CF₃, —C₂F₅, —C₃F₇;
(f) (per)fluoro-oxyalkylvinylethers of formula CF₂═CFOX₀, wherein X₀ is a C₁-C₁₂ oxyalkyl group or a C₁-C₁₂ (per)fluorooxyalkyl group having one or more ether groups, e.g. perfluoro-2-propoxy-propyl group;
(g) fluoroalkyl-methoxy-vinylethers of formula CF₂═CFOCF₂OR_{f2}, wherein R_{f2} is a C₁-C₆ fluoro- or perfluoroalkyl group, e.g. —CF₃, —C₂F₅, —C₃F₇ or a C₁-C₆ (per)fluorooxyalkyl group having one or more ether groups, e.g. —C₂F₅—O—CF₃;
(h) fluorodioxoles of formula:

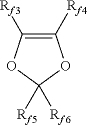

wherein each of R_{f3}, R_{f4}, R_{f5} and R_{f6}, equal to or different from each other, is independently a fluorine atom, a C₁-C₆ fluoro- or per(halo)fluoroalkyl group, optionally comprising one or more oxygen atoms, e.g. —CF₃, —C₂F₅, —C₃F₇, —OCF₃, —OCF₂CF₂OCF₃.

Most preferred fluorinated comonomers (F) are tetrafluoroethylene (TFE), trifluoroethylene (TrFE), chlorotrifluoroethylene (CTFE), hexafluoropropylene (HFP), perfluoromethyl vinyl ether (PMVE), perfluoropropyl vinyl ether (PPVE) and vinyl fluoride.

Should the polymer (F) comprise recurring units derived from at least one comonomer (C), the polymer (F) comprises typically from 1% to 40% by moles, preferably from 2% to 35% by moles, more preferably from 3% to 20% by moles of recurring units derived from at least one comonomer (C).

The polymer (F) may further comprise recurring units derived from at least one (meth)acrylic monomer (MA) having formula (I) here below:

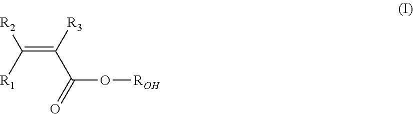

wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

Should the polymer (F) comprise recurring units derived from at least one (meth)acrylic monomer (MA), the polymer (F) typically comprises at least 0.01% by moles, preferably at least 0.02% by moles, more preferably at least 0.03% by moles of recurring units derived from at least one (meth)acrylic monomer (MA) having formula (I) as described above.

Should the polymer (F) comprise recurring units derived from at least one (meth)acrylic monomer (MA), the polymer (F) typically comprises at most 10% by moles, preferably at most 5% by moles, more preferably at most 2% by moles of recurring units derived from at least one (meth)acrylic monomer (MA) having formula (I) as described above.

The (meth)acrylic monomer (MA) preferably complies with formula (II) here below:

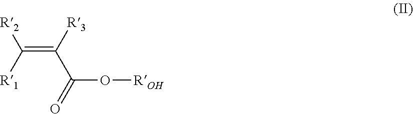

wherein:
R′₁, R′₂ and R′₃ are hydrogen atoms, and
R′_{OH} is a hydrogen atom or a C₁-C₅ hydrocarbon moiety comprising at least one hydroxyl group.

Non-limitative examples of (meth)acrylic monomers (MA) include, notably, acrylic acid, methacrylic acid, hydroxyethyl(meth)acrylate, hydroxypropyl(meth)acrylate, hydroxyethylhexyl(meth)acrylate.

The (meth)acrylic monomer (MA) is more preferably selected from the followings:
hydroxyethyl acrylate (HEA) of formula:

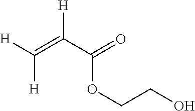

2-hydroxypropyl acrylate (HPA) of either of formulae:

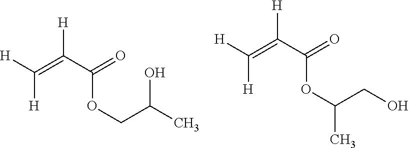

acrylic acid (AA) of formula:

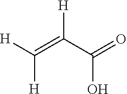

and mixtures thereof.

The (meth)acrylic monomer (MA) is even more preferably acrylic acid (AA) or hydroxyethyl acrylate (HEA).

The polymer (F) may be semi-crystalline or amorphous.

The term “semi-crystalline” is hereby intended to denote a polymer (F) having a heat of fusion of from 10 to 90 J/g, preferably of from 30 to 60 J/g, more preferably of from 35 to 55 J/g, as measured according to ASTM D3418-08.

The term “amorphous” is hereby to denote a polymer (F) having a heat of fusion of less than 5 J/g, preferably of less than 3 J/g, more preferably of less than 2 J/g, as measured according to ASTM D-3418-08.

The aqueous latex of the coating composition of the process of the invention is prepared by aqueous emulsion polymerization of vinylidene fluoride (VdF), optionally in the presence of at least one comonomer (C) as defined above and optionally in the presence of at least one (meth)acrylic monomer (MA) having formula (I) as defined above.

The aqueous emulsion polymerization process as detailed above is typically carried out in an aqueous medium the presence of at least one radical initiator.

Polymerization pressure ranges typically between 20 and 70 bar, preferably between 25 and 65 bar.

The skilled in the art will choose the polymerization temperature having regards, inter alia, of the radical initiator used. Polymerization temperature is generally selected in the range comprised between 60° C. and 135° C., preferably between 90° C. and 130° C.

While the choice of the radical initiator is not particularly limited, it is understood that radical initiators suitable for an aqueous emulsion polymerization process are selected from compounds capable of initiating and/or accelerating the polymerization process.

Inorganic radical initiators may be used and include, but are not limited to, persulfates such as sodium, potassium and ammonium persulfates, permanganates such as potassium permanganate.

Also, organic radical initiators may be used and include, but are not limited to, the followings: acetylcyclohexanesulfonyl peroxide; diacetylperoxydicarbonate; dialkylperoxydicarbonates such as diethylperoxydicarbonate, dicyclohexylperoxydicarbonate, di-2-ethylhexylperoxydicarbonate; tert-butylperneodecanoate; 2,2′-azobis(4-methoxy-2,4-dimethylvaleronitrile; tert-butylperpivalate; dioctanoylperoxide; dilauroyl-peroxide; 2,2′-azobis (2,4-dimethylvaleronitrile); tert-butylazo-2-cyanobutane; dibenzoylperoxide; tert-butyl-per-2ethylhexanoate; tert-butylpermaleate; 2,2′-azobis(isobutyronitrile); bis(tert-butylperoxy)cyclohexane; tert-butyl-peroxyisopropylcarbonate; tert-butylperacetate; 2,2′-bis(tert-butylperoxy)butane; dicumyl peroxide; di-tert-amyl peroxide; di-tert-butyl peroxide (DTBP); p-methane hydroperoxide; pinane hydroperoxide; cumene hydroperoxide; and tert-butyl hydroperoxide.

Other suitable radical initiators notably include halogenated free radical initiators such as chlorocarbon based and fluorocarbon based acyl peroxides such as trichloroacetyl peroxide, bis(perfluoro-2-propoxy propionyl) peroxide, [CF₃CF₂CF₂OCF(CF₃)COO]₂, perfluoropropionyl peroxides, (CF₃CF₂CF₂COO)₂, (CF₃CF₂COO)₂, {(CF₃CF₂CF₂)—[CF(CF₃)CF₂O]ₘ—CF(CF₃)—COO}₂ where m=0-8, [ClCF₂(CF₂)ₙCOO]₂, and [HCF₂(CF₂)ₙCOO]₂ where n=0-8; perfluoroalkyl azo compounds such as perfluoroazoisopropane, [(CF₃)₂CFN═]₂, R^{∘}N═NR^{∘}, where R^{∘} is a linear or branched perfluorocarbon group having 1-8 carbons; stable or hindered perfluoroalkane radicals such as hexafluoropropylene trimer radical, [(CF₃)₂CF]₂(CF₂CF₂)C^{} radical and perfluoroalkanes.

Redox systems, comprising at least two components forming a redox couple, such as dimethylaniline-benzoyl peroxide, diethylaniline-benzoyl peroxide and diphenylamine-benzoyl peroxide may also be used as radical initiators to initiate the polymerization process.

Most preferred radical initiators which may be advantageously used in the aqueous emulsion polymerization as detailed above are inorganic radical initiators as defined above, organic radical initiators as defined above and mixtures thereof.

Among inorganic radical initiators, ammonium persulfate is particularly preferred.

Among organic radical initiators, the peroxides having a self-accelerating decomposition temperature (SADT) higher than 50° C. are particularly preferred, such as for instance: di-tert-butyl peroxide (DTBP), diterbutylperoxyisopropylcarbonate, terbutyl(2-ethyl-hexyl)peroxycarbonate, terbutylperoxy-3,5,5-trimethylhexanoate.

One or more radical initiators as defined above may be added to the aqueous medium as defined above in an amount ranging advantageously from 0.001% to 20% by weight based on the weight of the aqueous medium.

The aqueous emulsion polymerization process as detailed above is typically carried out in the presence of a chain transfer agent. The chain transfer agent is generally selected from those known in the polymerization of fluorinated monomers such as ketones, esters, ethers or aliphatic alcohols having from 3 to 10 carbon atoms like, e.g., acetone, ethylacetate, diethylether, methyl-ter-butyl ether, isopropyl alcohol; chloro(fluoro)carbons, optionally containing hydrogen, having from 1 to 6 carbon atoms, like, e.g., chloroform, trichlorofluoromethane; bis(alkyl)carbonates wherein the alkyl has from 1 to 5 carbon atoms like, e.g., bis(ethyl)carbonate, bis(isobutyl)carbonate. The chain transfer agent may be fed to the aqueous medium at the beginning, continuously or in discrete amounts (step-wise) during the polymerization, continuous or stepwise feeding being preferred.

The aqueous emulsion polymerization process as detailed above may be carried out in the presence of at least one non-functional perfluoropolyether (PFPE) oil and/or at least one fluorinated surfactant [surfactant (FS)].

By “non-functional perfluoropolyether (PFPE) oil” it is hereby intended to denote a perfluoropolyether (PFPE) oil comprising a (per)fluoropolyoxyalkylene chain [chain (R_{f})] and non-functional end-groups.

The non-functional end groups of the perfluoropolyether (PFPE) oil are generally selected from fluoro(halo)alkyls having 1 to 3 carbon atoms, optionally comprising one or more halogen atoms different from fluorine or hydrogen atoms, e.g. CF₃—, C₂F₅—, C₃F₆—, ClCF₂CF(CF₃)—, CF₃CFClCF₂—, ClCF₂CF₂—, ClCF₂—.

The non-functional PFPE oil has a number average molecular weight advantageously comprised between 400 and 3000, preferably between 600 and 1500.

The non-functional PFPE oil is preferably selected from the followings:

T¹-O—[CF(CF₃)CF₂O]_{b1′}(CFYO)_{b2′}-T^{1′} (1)

wherein:
T¹ and T^{1′}, equal to or different from each other, are independently selected from —CF₃, —C₂F₅ and —C₃F₇ groups;
Y, equal or different at each occurrence, is selected from a fluorine atom and a —CF₃ group;
b1′ and b2′, equal to or different from each other, are independently integers ≧0 such that the b1′/b2′ ratio is comprised between 20 and 1000 and the (b1′+b2′) sum is comprised between 5 and 250; should b1′ and b2′ be both different from zero, the different recurring units are generally statistically distributed along the perfluoropolyoxyalkylene chain. Said products can be obtained by photooxidation of C₃F₆ as described in CA 786877 (MONTEDISON S.P.A.) Apr. 6, 1968 and by subsequent conversion of the end groups as described in GB 1226566 (MONTECATINI EDISON S.P.A.) 31 Mar. 1971.

T¹-O—[CF(CF₃)CF₂O]_{c1′}(C₂F₄O)_{c2′}(CFYO)_{c3′}-T^{1′} (2)

wherein:
T¹ and T^{1′}, equal to or different from each other, have the same meaning as defined above;
Y, equal or different at each occurrence, has the same meaning as defined above;
c1′, c2′ and c3′, equal to or different from each other, are independently integers ≧0 such that the (c1′+c2′+c3′) sum is comprised between 5 and 250; should at least two of c1′, c2′ and c3′ be different from zero, the different recurring units are generally statistically distributed along the perfluoropolyoxyalkylene chain.

Said products can be manufactured by photooxidation of a mixture of C₃F₆ and C₂F₄ and subsequent treatment with fluorine as described in U.S. Pat. No. 3,665,041 (MONTECATINI EDISON S.P.A.) 23 May 1972.

T¹-O—(C₂F₄O)_{d1′}(CF₂O)_{d2′}-T^{1′} (3)

wherein:
T¹ and T^{1′}, equal to or different from each other, have the same meaning as defined above;
d1′ and d2′, equal to or different from each other, are independently integers ≧0 such that the d1′/d2′ ratio is comprised between 0.1 and 5 and the (d1′+d2′) sum is comprised between 5 and 250; should d1′ and d2′ be both different from zero, the different recurring units are generally statistically distributed along the perfluoropolyoxyalkylene chain. Said products can be produced by photooxidation of C₂F₄ as reported in U.S. Pat. No. 3,715,378 (MONTECATINI EDISON S.P.A.) Jun. 2, 1973 and subsequent treatment with fluorine as described in U.S. Pat. No. 3,665,041 (MONTECATINI EDISON S.P.A.) 23 May 1972.

T²-O—[CF(CF₃)CF₂O]_{e′}-T^{2′} (4)

wherein:
T² and T^{2′}, equal to or different from each other, are independently selected from —C₂F₅ and —C₃F₇ groups;
e′ is an integer comprised between 5 and 250.

Said products can be prepared by ionic hexafluoropropylene epoxide oligomerization and subsequent treatment with fluorine as described in U.S. Pat. No. 3,242,218 (E. I. DU PONT DE NEMOURS AND CO.) 22 Mar. 1966.

T²-O—(CF₂CF₂O)_{f′}-T^{2′} (5)

wherein:
T² and T^{2′}, equal to or different from each other, have the same meaning as defined above;
f′ is an integer comprised between 5 and 250.

Said products can be obtained by a method comprising fluorinating a polyethyleneoxide, e.g. with elemental fluorine, and optionally thermally fragmentating the so-obtained fluorinated polyethyleneoxide as reported in U.S. Pat. No. 4,523,039 (THE UNIVERSITY OF TEXAS) Nov. 6, 1985.

T¹-O—(CF₂CF₂C(Hal′)₂O)_{g1′}—(CF₂CF₂CH₂O)_{g2′}—(CF₂CF₂CH(Hal′)O)_{g3′}-T^{1′} (6)

wherein:
T¹ and T^{1′}, equal to or different from each other, have the same meaning as defined above;
Hal′, equal or different at each occurrence, is a halogen selected from fluorine and chlorine atoms, preferably a fluorine atom;
g1′, g2′, and g3′, equal to or different from each other, are independently integers ≧0 such that the (g1′+g2′+g3′) sum is comprised between 5 and 250; should at least two of g1′, g2′ and g3′ be different from zero, the different recurring units are generally statistically distributed along the (per)fluoropolyoxyalkylene chain.

Said products may be prepared by ring-opening polymerizing 2,2,3,3-tetrafluorooxethane in the presence of a polymerization initiator to give a polyether comprising repeating units of the formula: —CH₂CF₂CF₂O—, and optionally fluorinating and/or chlorinating said polyether, as detailed in EP 148482 B (DAIKIN INDUSTRIES LTD.) 25 Mar. 1992.

R¹_{f}—{C(CF₃)₂—O—[C(R²_{f})₂]_{j1′}C(R²_{f})₂—O}ⱼ₂′—R¹_{f} (7)

wherein:
R¹_{f}, equal or different at each occurrence, is a C₁-C₆ perfluoroalkyl group;
R²_{f}, equal or different at each occurrence, is selected from a fluorine atom and a C₁-C₆ perfluoroalkyl group;
j1′ is equal to 1 or 2;
j2′ is an integer comprised between 5 and 250.

Said products can be produced by the copolymerization of hexafluoroacetone with an oxygen-containing cyclic comonomer selected from ethylene oxide, propylene oxide, epoxy-butane and/or trimethylene oxide (oxethane) or substituted derivatives thereof and subsequent perfluorination of the resulting copolymer, as detailed in patent application WO 87/00538 (LAGOW ET AL.) 29 Jan. 1987.

The non-functional PFPE oil is more preferably selected from the followings:

(1′) non-functional PFPE oils commercially available from Solvay Solexis S.p.A. under the trademark names GALDEN® and FOMBLIN®, said PFPE oils generally comprising at least one PFPE oil complying with either of formulae here below:

CF₃—[(OCF₂CF₂)ₘ—(OCF₂)ₙ]—OCF₃
m+n=40-180; m/n=0.5-2

CF₃—[(OCF(CF₃)CF₂)ₚ—(OCF₂)_{q}]—OCF₃
p+q=8-45; p/q=20-1000
   (2′) non-functional PFPE oils commercially available from Daikin under the trademark name DEMNUM®, said PFPEs generally comprising at least one PFPE complying with formula here below:

F—(CF₂CF₂CF₂)ₙ—(CF₂CF₂CH₂O)ⱼ—CF₂CF₃
j=0 or integer >0; n+j=10-150
   (3′) non-functional PFPE oils commercially available from Du Pont de Nemours under the trademark name KRYTOX®, said PFPEs generally comprising at least one low-molecular weight, fluorine end-capped, homopolymer of hexafluoropropylene epoxide complying with formula here below:

F—(CF(CF₃)CF₂O)ₙ—CF₂CF₃
n=10-60

The non-functional PFPE oil is even more preferably selected from those having formula (1′) as described above.

The fluorinated surfactant (FS) typically complies with formula (III) here below:

R_{f§}(X⁻)ₖ(M⁺)ₖ (III)

wherein:
R_{f§} is selected from a C₅-C₁₆ (per)fluoroalkyl chain, optionally comprising one or more catenary or non-catenary oxygen atoms, and a (per)fluoropolyoxyalkyl chain,
X⁻ is selected from —COO⁻, —PO₃⁻ and —SO₃⁻,
M⁺ is selected from NH₄⁺ and an alkaline metal ion, and
k is 1 or 2.

Non-limitative examples of fluorinated surfactants (FS) suitable for the aqueous emulsion polymerization process of the invention include, notably, the followings:

(a) CF₃(CF₂)ₙ₀COOM′, wherein no is an integer ranging from 4 to 10, preferably from 5 to 7, preferably n₁ being equal to 6, and M′ represents NH₄, Na, Li or K, preferably NH₄;
(b) T-(C₃F₆O)ₙ₁(CFXO)ₘ₁CF₂COOM″, wherein T represents a Cl atom or a perfluoroalkoxyde group of formula CₓF_{2x+1-x′}Cl_{x′}O, wherein x is an integer ranging from 1 to 3 and x′ is 0 or 1, n₁ is an integer ranging from 1 to 6, m₁ is an integer ranging from 0 to 6, M″ represents NH₄, Na, Li or K and X represents F or —CF₃;
(c) F—(CF₂CF₂)ₙ₂—CH₂—CH₂—RO₃M′″, in which R is a phosphorus or a sulphur atom, preferably R being a sulphur atom, M′″ represents NH₄, Na, Li or K and n₂ is an integer ranging from 2 to 5, preferably n₂ being equal to 3;
(d) A-R_{bf}—B bifunctional fluorinated surfactants, wherein A and B, equal to or different from each other, have formula —(O)ₚCFX″—COOM*, wherein M* represents NH₄, Na, Li or K, preferably M* representing NH₄, X″ is F or —CF₃ and p is an integer equal to 0 or 1, and R_{bf} is a divalent (per)fluoroalkyl or (per)fluoropolyether chain such that the number average molecular weight of A-R_{bf}—B is in the range of from 300 to 1800; and (e) mixtures thereof.

Preferred fluorinated surfactants (FS) comply with formula (b) as described above.

Aqueous emulsion polymerization processes as detailed above have been described in the art (see e.g. U.S. Pat. No. 4,990,283 (AUSIMONT S.P.A.) May 2, 1991, U.S. Pat. No. 5,498,680 (AUSIMONT S.P.A.) Dec. 3, 1996 and U.S. Pat. No. 6,103,843 (AUSIMONT S.P.A.) 15 Aug. 2000.

The aqueous latex of the coating composition of the process of the invention may further comprise at least one fluorinated surfactant [surfactant (FS)] as defined above.

One or more hydrogenated surfactants [surfactant (H)] may optionally be further added to the aqueous latex of the coating composition of the process of the invention.

Non-limitative examples of suitable hydrogenated surfactants (H) include, notably, ionic and non-ionic hydrogenated surfactants such as 3-allyloxy-2-hydroxy-1-propane sulfonic acid salts, polyvinylphosphonic acid, polyacrylic acids, polyvinyl sulfonic acid, and salts thereof, octylphenol ethoxylates, polyethylene glycol and/or polypropylene glycol and the block copolymers thereof, alkyl phosphonates and siloxane-based surfactants.

Hydrogenated surfactants (H) which may be preferably added to the aqueous latex of the coating composition of the process of the invention are non-ionic surfactants commercially available as TRITON® X series and PLURONIC® series.

The Applicant thinks, without this limiting the scope of the present invention, that the polymer (F) thanks to its primary particles in the aqueous latex as obtained by aqueous emulsion polymerization provides the non-electroactive inorganic filler material with enhanced cohesion and ensures successfully obtaining composite separators having outstanding mechanical properties and ionic conductivity to be suitably used in electrochemical cells.

The coating composition of the process of the invention comprises water in an amount advantageously comprised between 15% and 97% by weight, preferably between 30% and 75% by weight, based on the total weight of the coating composition.

The coating composition of the process of the invention may optionally further comprise one or more organic solvents (S), preferably in an amount of less than 10% by weight, more preferably of less than 5% by weight, based on the total weight of the coating composition.

Non-limitative examples of suitable organic solvents (S) include, notably, those capable of dissolving the polymer (F).

Most preferred organic solvents (S) include, notably, the followings: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, trimethyl phosphate and mixtures thereof.

The coating composition of the process of the invention preferably comprises:
from 2% to 40% by weight, based on the total weight of the coating composition, of at least one vinylidene fluoride (VdF) polymer [polymer (F)] under the form of primary particles having an average primary particle size of less than 1 μm, as measured according to ISO 13321,
from 0.1% to 60% by weight, based on the total weight of the coating composition, of at least one non-electroactive inorganic filler material,
from 15% to 97% by weight, based on the total weight of the coating composition, of water,
optionally, up to 2% by weight, based on the total weight of the coating composition, of at least one surfactant selected from a fluorinated surfactant (FS) as defined above, a hydrogenated surfactant (H) as defined above and mixtures thereof, and
optionally, less than 10% by weight, based on the total weight of the coating composition, of one or more organic solvents (S).

The coating composition of the process of the invention more preferably comprises:
from 10% to 25% by weight, based on the total weight of the coating composition, of at least one vinylidene fluoride (VdF) polymer [polymer (F)] under the form of primary particles having an average primary particle size of less than 1 μm, as measured according to ISO 13321,
from 5% to 30% by weight, based on the total weight of the coating composition, of at least one non-electroactive inorganic filler material,
from 30% to 75% by weight, based on the total weight of the coating composition, of water,
optionally, up to 1% by weight, based on the total weight of the coating composition, of at least one surfactant selected from a fluorinated surfactant (FS) as defined above, a hydrogenated surfactant (H) as defined above and mixtures thereof, and
optionally, less than 5% by weight, based on the total weight of the coating composition, of one or more organic solvents (S).

The coating composition of the process of the invention even more preferably is free from one or more organic solvents (S).

Very good results have been obtained when the process of the invention is carried out using a coating composition free from one or more organic solvents (S).

In step (ii) of the process of the invention, the coating composition is prepared preferably by dispersing at least one non-electroactive inorganic filler material into the aqueous latex comprising at least one polymer (F).

The coating composition so obtained is then commonly subjected to a shear mixing to ensure uniform distribution of the non-electroactive inorganic filler material(s) in the composition.

The skilled in the art will properly adapt the viscosity of the coating composition so as to enable obtaining by the process of the invention a uniform distribution of the non-electroactive inorganic filler material(s) within the composite separator so obtained.

The coating composition provided by step (ii) of the process of the invention may further comprise one or more additives.

Non-limitative examples of suitable additives which may be advantageously added to the coating composition of the process of the invention include, notably, thickeners.

The coating composition provided by step (ii) of the process of the invention is advantageously free from one or more electroactive particulate materials.

By the term “electroactive particulate material”, it is hereby intended to denote an electrically conducting particulate material which can be reduced or oxidised. Electroactive particulate materials are particularly suitable for the manufacture of electrically conducting electrodes for electrochemical cells.

In step (iii) of the process of the invention, the coating composition is typically applied onto at least one surface of a substrate layer by a technique selected from casting, spray coating, roll coating, doctor blading, slot die coating, gravure coating, ink jet printing, spin coating and screen printing, brush, squeegee, foam applicator, curtain coating, vacuum coating.

By the term “substrate layer”, it is hereby intended to denote either a monolayer substrate consisting of a single layer or a multilayer substrate comprising at least two layers adjacent to each other.

Should the substrate layer be a multilayer substrate, in step (iii) of the process of the invention the coating composition is applied onto at least one surface of the outer layer of said substrate.

The substrate layer may be either a non-porous substrate layer or a porous substrate layer.

Should the substrate layer be a multilayer substrate, the outer layer of said substrate may be either a non-porous substrate layer or a porous substrate layer.

By the term “porous substrate layer”, it is hereby intended to denote a substrate layer containing pores of finite dimensions.

By the term “non-porous substrate layer”, it is hereby intended to denote a dense substrate layer free from pores of finite dimensions.

Non-limitative examples of suitable porous substrate layers include, notably, separator layers such as composite separator layers and electrode layers such as composite electrode layers.

By the term “composite electrode”, it is hereby intended to denote an electrode wherein electroactive particulate materials are incorporated into a polymeric binder material.

In step (iv) of the process of the invention, the coating composition layer is dried preferably at a temperature comprised between 100° C. and 200° C., preferably between 100° C. and 180° C.

The composite separator obtained from the process of the invention typically comprises:
from 10% to 99% by weight, preferably from 15% to 95% by weight, based on the total weight of the composite separator, of at least one polymer (F), and
from 90% to 1% by weight, preferably from 85% to 5% by weight, based on the total weight of the composite separator, of at least one non-electroactive inorganic filler material.

The composite separator obtained from the process of the invention may be either a monolayer composite separator consisting of a single composite separator layer or a multilayer composite separator comprising at least two composite separator layers adjacent to each other.

A multilayer composite separator is typically obtained according to the process of the present invention, wherein steps (i) to (iv) are repeated two or more times and the coating composition is equal or different at each occurrence.

Should the composite separator be a multilayer composite separator, each composite separator layer comprises at least one non-electroactive inorganic filler material in an amount equal or different at each occurrence and typically comprised between 1% and 90% by weight, preferably between 5% and 85% by weight, based on the total weight of the composite separator layer.

Should the composite separator be a multilayer composite separator, each composite separator layer has a thickness equal or different at each occurrence and typically comprised between 10% and 90% of the total thickness of the composite separator.

According to a first embodiment of the process of the invention, the composite separator as provided by step (iv) is removed from at least one surface of the substrate layer to provide for a self-supporting composite separator.

The composite separator obtained according to this first embodiment of the process of the invention is advantageously used for the manufacture of an electrochemical cell.

According to a second embodiment of the process of the invention, the composite separator as provided by step (iv) is adhered to at least one surface of the substrate layer to provide for a composite separator supported on said substrate layer.

According to a first variant of this second embodiment of the process of the invention, should the substrate layer be a composite separator layer, a multilayer composite separator is obtained from the process of the invention which comprises at least two composite separator layers adjacent to each other.

According to a second variant of this second embodiment of the process of the invention, should the substrate layer be an electrode layer, a laminated composite separator is obtained from the process of the invention which comprises at least one composite separator layer adhered to at least one surface of at least one electrode layer.

Another object of the present invention is a coating composition comprising:
an aqueous latex comprising at least one vinylidene fluoride (VdF) polymer [polymer (F)] under the form of primary particles having an average primary particle size of less than 1 μm, as measured according to ISO 13321,
at least one non-electroactive inorganic filler material,
optionally, up to 2% by weight, based on the total weight of the coating composition, of at least one surfactant selected from a fluorinated surfactant (FS) as defined above, a hydrogenated surfactant (H) as defined above and mixtures thereof, and
optionally, less than 10% by weight, based on the total weight of the coating composition, of one or more organic solvents (S), said coating composition being free from one or more electroactive particulate materials.

The coating composition of the invention is defined as above.

The coating composition of the invention can be advantageously used in the process of the invention for the manufacture of an electrically insulating composite separator for an electrochemical cell.

The Applicant has surprisingly found that the coating composition of the invention advantageously enables manufacturing composite separators suitable for use in electrochemical cells without the need for isolating polymer powders from said compositions and re-dispersing them in suitable organic solvents.

The Applicant has also found that the coating composition of the invention successfully provides for composite separators having enhanced mechanical properties and ionic conductivity to be successfully used in electrochemical cells.

The coating composition of the invention is advantageously manufactured by:
providing an aqueous latex comprising at least one polymer (F) as defined above, and
admixing said aqueous latex with at least one non-electroactive inorganic filler material as defined above,
optionally in the presence of up to 2% by weight, based on the total weight of the coating composition, of at least one surfactant selected from a fluorinated surfactant (FS) as defined above, a hydrogenated surfactant (H) as defined above and mixtures thereof, and
optionally in the presence of less than 10% by weight, based on the total weight of the coating composition, of one or more organic solvents (S).

The coating composition of the invention is preferably free from one or more organic solvents (S).

Also, another object of the present invention is the composite separator obtained from the process of the invention.

Still, another object of the present invention is an electrochemical cell comprising the composite separator obtained from the process of the invention.

The electrochemical cell of the invention typically comprises a positive electrode, a negative electrode and the composite separator obtained from the process of the invention.

The electrochemical cell of the invention is typically manufactured by laminating the positive electrode and the negative electrode in a facing relationship under certain pressure and temperature to provide for a laminated composite separator between the positive and negative electrodes.

The process of the invention is particularly adapted for the manufacture of composite separators suitable for use in Lithium-ion secondary batteries.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### Determination of Total Average Monomer (MA) Content

The total average monomer (MA) content in vinylidene fluoride (VdF) polymers was determined by acid-base titration.

A sample of 1.0 g of polymer was dissolved in acetone at a temperature of 70° C. Water (5 ml) was then added dropwise under vigorous stirring so as to avoid coagulation of the polymer. The titration was then carried out with aqueous NaOH having a concentration of 0.01 N until complete neutralization, with neutrality transition at about −170 mV.

### Determination of Ionic Conductivity

The composite separators were dipped in an electrolyte solution consisting of LiPF₆ 1M in a mixture of ethylene carbonate/dimethyl carbonate (1/1 weight) at room temperature for 24 hours. They were then put between two stainless steel electrodes and sealed in a container.

The ionic conductivity (σ) was measured using the following equation:

$$σ = \frac{d}{( {R}_{b} \times S )}$$

wherein d is the thickness of the film, R_{b} is the bulk resistance and S is the area of the stainless steel electrode.

### EXAMPLE 1

### Aqueous VdF-AA Polymer Latex

### (A) Manufacture of Aqueous VdF-AA Polymer Latex

In a 21 lt. horizontal reactor autoclave equipped with baffles and stirrer working at 40 rpm, 14 lt. of demineralised water were introduced, followed by 0.1 g of a 20% by weight aqueous solution of FLUOROLINK® 7800 SW sodium salt fluorinated surfactant. The pressure of 35 bar was maintained constant throughout the whole trial by feeding VdF gaseous monomer. Then the temperature was brought to 85° C. and 400 ml of a 37.5 g/l aqueous solution of ammonium persulfate were added over a period of 20 minutes. For the whole duration of the trial, 20 ml of a solution of acrylic acid (AA) (2.3% w/w acrylic acid in water) were fed every 250 g of polymer synthesized. When 5000 g of the mixture were fed, the feeding mixture was interrupted, then the pressure was let to fall down up to 11 bar while keeping the reaction temperature constant. Final reaction time was 150 min. The reactor was cooled to room temperature, the latex was unloaded and 1000 g of a 10% by weight aqueous solution of PLURONIC® F108 hydrogenated surfactant were added upon stirring. The VdF-AA polymer so obtained contained 0.15% by moles of acrylic acid (AA) monomer. The aqueous latex so obtained had a solid content of 26% by weight. The VdF-AA polymer was dispersed in the aqueous latex under the form of primary particles having an average primary size of 340 nm, as measured according to ISO 13321.

### (B) Manufacture of a Composite Separator

An aqueous composition was prepared by mixing 10.85 g of the VdF-AA polymer latex obtained according to Example 1-(A), 7.0 g of SiO₂ particles, 6.95 g of demineralised water and 0.2 g of carboxylated methyl cellulose thickener. The mixture was homogenised by moderate stirring using a Dispermat equipped with a flat PTFE disc.

A composite separator was obtained casting the aqueous composition so obtained on a glass support by doctor blading and drying the layer so obtained in an oven with three temperature steps held at 60° C., 100° C. and 180° C., each for about 30 minutes.

The thickness of the dried coating layer was about 30 μm.

The separator so obtained was composed by 28% by weight of the VdF-AA polymer binder, 70% by weight of SiO₂ particles and 2% by weight of the thickener.

### COMPARATIVE EXAMPLE 1

### VdF-AA Polymer Powder

### (A′) Manufacture of VdF-AA Polymer Powder

The same procedure as detailed in Example 1-(A) was followed but no hydrogenated surfactant was added to the latex. The latex was discharged and coagulated by freezing for 48 hours. The fluoropolymer obtained was washed with demineralised water and dried at 80° C. for 48 hours. The VdF-AA polymer powder so obtained contained 0.15% by moles of acrylic acid (AA) monomer.

### (B′) Manufacture of a Composite Separator

A composition was prepared by mixing 0.9 g of the VdF-AA polymer powder obtained according to comparative Example 1-(A′), 12.0 g of N-methylpyrrolidone (NMP) and 2.0 g of SiO₂ particles.

The mixture was homogenised by moderate stirring using a Dispermat equipped with a flat PTFE disc.

A composite separator was obtained casting the solution composition so obtained on a glass support by doctor blading and drying the layer so obtained in an oven under vacuum at 130° C., for about 60 minutes. The thickness of the dried coating layer was about 35 μm.

The separator so obtained was composed by 30% by weight of the VdF-AA polymer binder and 70% by weight of SiO₂ particles.

### (C′) Manufacture of Aqueous VdF-AA Polymer Slurry

A composition was prepared by dispersing the VdF-AA polymer powder obtained according to comparative Example 1-(A′), thus obtaining an aqueous VdF-AA polymer slurry which was not suitable for the manufacture of a composite separator for an electrochemical cell according to the process of the invention.

As shown in Table 1 below, the composite separators obtained according to the process of the invention (Example 1-(B)) successfully exhibited outstanding ionic conductivity values to be suitably used in electrochemical cells as compared with composite separators prepared with standard well-known solvent-based processes (comparative Example 1-(B′)).

TABLE 1

| | Conductivity |
|---|---|
| Run | [S/cm] |
| Example 1-(B) | 5 × 10⁻⁴ |
| C. Example 1-(B′) | 1 × 10⁻³ |

It has been thus found that by the process of the present invention it is advantageously possible to manufacture composite separators suitable for use in electrochemical cells by using a water-based environmentally-friendly and safe process.

1. A process for the manufacture of a composite separator for an electrochemical cell, said process comprising:
applying a coating composition onto at least one surface of a substrate layer to provide a coating composition layer, the coating composition comprising:
an aqueous latex comprising at least one vinylidene fluoride polymer (F) under the form of primary particles having an average primary particle size of less than 1 μm, as measured according to ISO 13321, and
at least one non-electroactive inorganic filler material; and
drying said coating composition layer at a temperature of at least 60° C. to provide said composite separator.

2. The process according to claim 1, wherein the aqueous latex has homogeneously dispersed therein primary particles of at least polymer (F) having an average primary particle size comprised between 50 nm and 600 nm, as measured according to ISO 13321.

3. The process according to claim 1, wherein polymer (F) comprises recurring units derived from at least one comonomer (C), said comonomer (C) being different from vinylidene fluoride.

4. The process according to claim 3, wherein the comonomer (C) is a hydrogenated comonomer (H) or a fluorinated comonomer (F).

5. The process according to claim 1, wherein polymer (F) comprises recurring units derived from at least one (meth)acrylic monomer (MA) of formula (I): 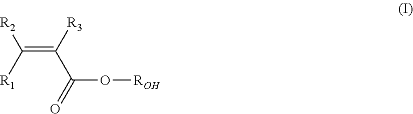
wherein:
R₁, R₂ and R₃, equal to or different from each other, are independently selected from a hydrogen atom and a C₁-C₃ hydrocarbon group, and
R_{OH} is a hydrogen atom or a C₁-C₅ hydrocarbon moiety comprising at least one hydroxyl group.

6. The process according to claim 1, wherein the coating composition comprises:
from 2% to 40% by weight, based on the total weight of the coating composition, of at least one vinylidene fluoride polymer under the form of primary particles having an average primary particle size of less than 1 μm, as measured according to ISO 13321,
from 0.1% to 60% by weight, based on the total weight of the coating composition, of at least one non-electroactive inorganic filler material,
from 15% to 97% by weight, based on the total weight of the coating composition, of water,
optionally, up to 2% by weight, based on the total weight of the coating composition, of at least one surfactant selected from a fluorinated surfactant (FS), a hydrogenated surfactant (H) and mixtures thereof, and
optionally, less than 10% by weight, based on the total weight of the coating composition, of one or more organic solvents (S).

7. The process according to claim 1, wherein the non-electroactive inorganic filler material has an electrical resistivity (ρ) of at least 0.1×10¹⁰ ohm·cm, as measured at 20° C. according to ASTM D 257.

8. The process according to claim 1, wherein the coating composition is prepared by dispersing at least one non-electroactive inorganic filler material into the aqueous latex comprising at least one polymer (F) under the form of primary particles having an average primary particle size of less than 1 μm, as measured according to ISO 13321.

9. The process according to claim 1, wherein the coating composition is free from one or more organic solvents (S).

10. The process according to claim 1, wherein the coating composition is free from one or more electroactive particulate materials.

11. The process according to claim 1, wherein the composite separator is removed from at least one surface of the substrate layer to provide for a self-supporting composite separator.

12. The process according to claim 1, wherein the composite separator is adhered to at least one surface of the substrate layer to provide for a composite separator supported on said substrate layer.

13. A coating composition comprising:
an aqueous latex comprising at least one vinylidene fluoride polymer (F) under the form of primary particles having an average primary particle size of less than 1 μm, as measured according to ISO 13321,
at least one non-electroactive inorganic filler material,
optionally, up to 2% by weight, based on the total weight of the coating composition, of at least one surfactant selected from a fluorinated surfactant (FS), a hydrogenated surfactant (H) and mixtures thereof, and
optionally, less than 10% by weight, based on the total weight of the coating composition, of one or more organic solvents (S),
said coating composition being free from one or more electroactive particulate materials.

14. The coating composition according to claim 13, wherein the aqueous latex is admixed with at least one non-electroactive inorganic filler material,
optionally in the presence of up to 2% by weight, based on the total weight of the coating composition, of at least one surfactant selected from a fluorinated surfactant (FS), a hydrogenated surfactant (H) and mixtures thereof, and
optionally in the presence of less than 10% by weight, based on the total weight of the coating composition, of one or more organic solvents (S).

15. The coating composition according to claim 13, said composition being free from one or more organic solvents (S).

16. The process according to claim 1, wherein the coating composition layer is dried at a temperature of at least 100° C.

17. The process according to claim 1, wherein the coating composition layer is dried at a temperature of at least 180° C.

18. The process according to claim 2, wherein the aqueous latex has homogeneously dispersed therein primary particles of at least polymer (F) having an average primary particle size comprised between 60 nm and 500 nm, as measured according to ISO 13321.

19. The process according to claim 2, wherein the aqueous latex has homogeneously dispersed therein primary particles of at least polymer (F) having an average primary particle size comprised between 80 nm and 400 nm, as measured according to ISO 13321.

20. The process according to claim 7, wherein the non-electroactive inorganic filler material has an electrical resistivity (ρ) of at least 0.1×10¹² ohm·cm, as measured at 20° C. according to ASTM D 257.
